(19) United States
(12) Patent Application Publication
(10) Pub. No.: US 2024/0284953 A1
(43) Pub. Date: Aug. 29, 2024

(54) COLLAGEN-RICH FOOD OR BEVERAGE PRODUCT

(71) Applicant: MORINAGA & CO., LTD, Tokyo (JP)

(72) Inventors: Ayaka OKUBO, Kanagawa (JP); Yusuke NOGUCHI, Kanagawa (JP)

(73) Assignee: MORINAGA & CO., LTD, Tokyo (JP)

(21) Appl. No.: 18/588,823

(22) Filed: Feb. 27, 2024

(30) Foreign Application Priority Data
Feb. 28, 2023 (JP) 2023-030507

(51) Int. Cl. A23L 27/00; A23J 3/04; A23L 2/56; A23L 2/66; A23L 27/20

(52) U.S. Cl. CPC A23L 27/84; A23J 3/04; A23L 2/56; A23L 2/66; A23L 27/2024; A23L 27/2026; A23L 27/2052

(57) ABSTRACT

A food or beverage product comprising: ethyl butyrate; and 5 mass or more of collagen.

### BACKGROUND

### Technical Field

The present invention relates to a collagen-rich food or beverage product having a good flavor.

### Related Art

In recent years, collagen-containing beverages have been widely distributed.

Collagen is one of components constituting dermis, ligaments, tendons, cartilage, bones, and the like. It has been reported that oral intake of collagen has an effect such as improvement of skin quality.

However, collagen has a characteristic odor and taste (hereinafter, described as an off-flavor), and when added to a food or beverage product, the flavor may be impaired.

Here, JP 2019-041696 A discloses an oral composition in which a unique odor and taste of a placenta extract and/or a collagen peptide is masked. As disclosed in JP 2019-041696 A, addition of linalool and γ-decalactone is known as a method for reducing an odor of collagen.

Further, JP 2018-042575 A discloses a method for adding linalool and ethyl acetate to reduce an odor caused by collagen peptides.

### SUMMARY

While various new palatable food or beverage products have been proposed, further development of novel collagen food or beverage products has been required.

Also, in the development of new palatable food or beverage products, there is a problem that an off-flavor characteristic to collagen is easily evoked when the content mass of collagen is increased.

In view of the above circumstances, the present invention provides a food or beverage product in which an off-flavor characteristic to collagen is masked in a food or beverage containing a specific amount or more of collagen.

As a result of intensive studies by the present inventors, they have found that specific components such as linalool, limonene, and lactones, including ethyl butyrate, have a masking effect on an off-flavor characteristic to collagen in the production of a food or beverage product containing a specific amount or more of collagen, and have completed the present invention.

That is, the present invention for solving the above problems provides a food or beverage product containing ethyl butyrate and 5 mass % or more of collagen.

According to the present invention, since ethyl butyrate masks an off-flavor characteristic to collagen, it is possible to provide a collagen-rich food or beverage product having a good flavor.

According to the present invention, when collagen is contained at a lower limit value or more, it is possible to mask the off-flavor characteristic to collagen.

In a preferred mode of the present invention, a content mass ratio of ethyl butyrate to collagen is in a range of 1:400 to 1:800.

In a preferred mode of the present invention, the food or beverage product includes one kind or two or more kinds selected from linalool, limonene, and lactones.

The present inventors have further found that linalool, limonene, and lactones mask the off-flavor characteristic to collagen. Thus, according to the present invention, containing the substances described above makes it possible to mask the off-flavor characteristic to collagen, when collagen is contained at a lower limit value or more. Further, in a mode containing the substances described above, the off-flavor characteristic to collagen can be masked continuously from the start of eating.

In a preferred mode of the present invention, a content mass ratio of one or more substances selected from the group consisting of linalool, limonene, and lactones to collagen is in a range of 1:400 to 1:500.

In a preferred mode of the present invention, a content mass ratio of ethyl butyrate to linalool and/or limonene is in a range of 1:1 to 1:3.3.

In a preferred mode of the present invention, a content mass ratio of ethyl butyrate to lactones is in a range of 1:0.8 to 1:2.

Setting the content mass ratio of the components in the present invention within the above range makes it possible to more reliably mask the off-flavor characteristic to collagen.

In a preferred mode of the present invention, the lactones include δ-decalactone and/or δ-dodecalactone.

Further, the present invention also relates to a method for producing a food or beverage product containing collagen, the method including mixing 5 mass % or more of collagen with ethyl butyrate.

According to the present invention, it is possible to produce a food or beverage product containing a specific amount or more of collagen in which an off-flavor characteristic to collagen is masked.

Furthermore, the present invention also relates to a method for reducing an odor of collagen in a food or beverage product, in which the food or beverage product contains ethyl butyrate as an active substance and 5 mass % or more of collagen.

According to the present invention, it is possible to provide a method for reducing an off-flavor characteristic to collagen in a food or beverage product containing a high concentration of collagen.

According to the present invention, it is possible to provide a food or beverage in which an off-flavor characteristic to collagen is reduced when the food or beverage product contains a high concentration of collagen. Further, according to the present invention, it is possible to provide a highly palatable food or beverage product.

### DETAILED DESCRIPTION

Hereinafter, embodiment modes of the present invention will be described and provided for understanding of the present invention. Note that the following embodiment modes are examples embodying the present invention, and can be appropriately modified within the scope described in the claims.

In the present invention, the term “masking an off-flavor characteristic to collagen” means that a specific substance is added, thereby reducing the off-flavor derived from collagen in a food or beverage product containing a specific amount or more of collagen, as compared with that before the addition of the substance.

The term “flavor” as used herein refers to a scent or taste sensation evoked when a food or beverage product is put into the mouth.

As a result of intensive studies, the present inventors have found that the off-flavor derived from collagen in a food or beverage product containing a specific amount or more of collagen are divided into three based on the start of eating.

With regard to the off-flavor derived from collagen in a food or beverage product containing a specific amount or more of collagen, the flavor first evoked when eating (when the volatilization rate is the highest rate) is referred to as a top note, the flavor evoked in the middle of eating is referred to as a middle note, and the flavor evoked from the middle of eating to the end of eating is referred to as a last note in the present specification.

Specifically, the term “top note of flavor” refers to a scent or taste sensation that is evoked in the nasal cavity of an eater through the nostril for about several seconds, from immediately before eating to the start of eating (perceived through the orthonasal pathway).

Further, the term “middle note of flavor” refers to a scent or taste sensation that is evoked in the nasal cavity of an eater after the eater has evoked the top note.

The term “last note of flavor” refers to a scent or taste sensation that is evoked in the nasal cavity of an eater through the oral cavity after the eater has eaten and swallowed a food or beverage product (perceived through the retronasal pathway).

Here, as described below, the timing at which the effect is particularly exhibited varies depending on each component used in the present invention.

### <Food or Beverage Product>

Hereinafter, preferred modes of the components contained in the food or beverage product of the present invention will be described.

In the description herein regarding the content mass (concentration) and physical properties of each component, the “entire food or beverage product” refers to the entire edible portion contained in a container and does not include the container unless otherwise specified.

### [Collagen]

Hereinafter, more preferred modes of collagen will be described.

The “component mass ratio” in the following description refers to the component mass ratio of collagen in the produced food or beverage product unless otherwise specified.

The origin of collagen contained in the food or beverage product of the present invention is not particularly limited.

Examples of the collagen used in the food or beverage product of the present invention include collagen derived from fish, birds, cattle, and pigs.

When collagen is prepared from a natural product, the method for preparing collagen is not particularly limited, and a method for preparing collagen from a natural product by an ordinary method can be adopted. Note that the collagen may be a commercially available pharmaceutical or food raw material.

The collagen referred to in the present invention also includes collagen peptides prepared by degrading and reducing the molecular weight of collagen through enzymatic treatment.

Here, the average molecular weight of the collagen peptide contained in the food or beverage product of the present invention is preferably 500 or more, more preferably 700 or more, and still more preferably 900 or more.

Further, the average molecular weight of the collagen peptide contained in the food or beverage product of the present invention is preferably 10,000 or less, more preferably 5,000 or less, and still more preferably 3,000 or less.

Here, the method for calculating the average molecular weight of collagen is not particularly limited as long as the method is capable of calculating the average molecular weight from the composition of the molecular weight of collagen in the product. Examples of the method include a method for calculating the average molecular weight by quantitative analysis using a high performance liquid chromatography apparatus and a method for calculating the average molecular weight by performing electrophoresis treatment after quantitative determination using an ELISA method.

The content mass of collagen in the food or beverage product is 5 mass % or more, preferably 6 mass % or more, more preferably 7.5 mass % or more, and still more preferably 15 mass % or more.

In the present invention, in a food or beverage product containing collagen at a lower limit value or more, an off-flavor derived from collagen can be reduced.

In addition, the content mass of collagen in the food or beverage product is preferably 40 mass % or less, more preferably 30 mass % or less, still more preferably 20 mass % or less, and particularly preferably 10 mass % or less.

### [Ethyl Butyrate]

Ethyl butyrate in the present invention is an organic compound represented by C₃H₇COOC₂H₅ and has a fruity odor.

The concentration of ethyl butyrate contained in the food or beverage product in the present invention is preferably 1 ppm or more, more preferably 10 ppm or more, and still more preferably 100 ppm or more relative to the entire food or beverage product.

An upper limit value of the concentration of ethyl butyrate is not particularly limited, but is preferably 350 ppm or less, more preferably 250 ppm or less, and still more preferably 150 ppm or less relative to the entire food or beverage product.

The ethyl butyrate in the present invention may be artificially synthesized by a chemical method or derived from a natural product. Preferably, ethyl butyrate derived from a natural product is used. Further, commercially available ethyl butyrate may be purchased and used.

In the present invention, the addition of ethyl butyrate makes it possible to reduce an off-flavor derived from collagen in a food or beverage product containing a specific amount or more of collagen.

Particularly, in a mode in which ethyl butyrate is added, it is possible to mask the top note of off-flavor in the food or beverage product containing a specific amount or more of collagen.

### [Linalool]

In a more preferred mode of the present invention, linalool is contained.

Here, linalool is a kind of monoterpene alcohol represented by C₁₀H₁₈O.

The concentration of linalool in the present invention is preferably 0.001 ppm or more, more preferably 1 ppm or more, still more preferably 10 ppm or more, yet still more preferably 50 ppm or more, and particularly preferably 100 ppm or more relative to the entire food or beverage product.

An upper limit value of the concentration of linalool is not particularly limited, but is preferably 500 ppm or less, more preferably 400 ppm or less, and still more preferably 300 ppm or less relative to the entire food or beverage product.

The linalool in the present invention may be artificially synthesized by a chemical method or derived from a natural product. Preferably, linalool derived from a natural product is used. Further, commercially available ethyl butyrate may be purchased and used.

In the present invention, the addition of linalool makes it possible to reduce an off-flavor derived from collagen in a food or beverage product containing a specific amount or more of collagen.

Particularly, in a mode in which linalool is added, it is possible to mask the top to last notes of off-flavor in the food or beverage product containing a specific amount or more of collagen.

### [Limonene]

In a more preferred mode of the present invention, limonene is contained.

Here, limonene is a monocyclic monoterpene represented by C₁₀H₁₆.

The concentration of limonene in the present invention is preferably 1 ppm or more, more preferably 10 ppm or more, still more preferably 50 ppm or more, and yet still more preferably 100 ppm or more relative to the entire food or beverage product.

An upper limit value of the concentration of limonene is not particularly limited, but is preferably 500 ppm or less, more preferably 400 ppm or less, and still more preferably 300 ppm or less relative to the entire food or beverage product.

The limonene in the present invention may be artificially synthesized by a chemical method or derived from a natural product. Preferably, limonene derived from a natural product is used. Further, commercially available ethyl butyrate may be purchased and used.

In the present invention, the addition of limonene makes it possible to reduce an off-flavor derived from collagen in a food or beverage product containing a specific amount or more of collagen.

Particularly, in a mode in which limonene is added, it is possible to mask the top and middle notes of off-flavor in the food or beverage product containing a specific amount or more of collagen.

### [Lactones]

In a more preferred mode of the present invention, lactone is contained.

Here, the “lactone contained in the food or beverage product” refers to a heterocyclic compound having two or more carbon atoms and one oxygen atom.

The concentration of lactone in the present invention is preferably 0.0001 ppm or more, more preferably 0.001 ppm or more, still more preferably 0.01 ppm or more, yet still more preferably 0.1 ppm or more, and particularly preferably 1 ppm or more relative to the entire food or beverage product.

In addition, an upper limit value of the concentration of lactone is not particularly limited, but is preferably 100 ppm or less, more preferably 500 ppm or less, still more preferably 400 ppm or less, and yet still more preferably 100 ppm or less relative to the entire food or beverage product.

Decalactone and/or dodecalactone can be preferably used as the lactones contained in the food or beverage product of the present invention.

In a preferred mode of the present invention, the content of decalactone in the entire food or beverage product is 0.0001 ppm or more, more preferably 0.001 ppm or more, still more preferably 0.01 ppm or more, yet still more preferably 0.1 ppm or more, even still more preferably 1 ppm or more, particularly preferably 10 ppm or more.

In a preferred mode of the present invention, the content of dodecalactone in the entire food or beverage product is 0.0001 ppm or more, more preferably 0.001 ppm or more, still more preferably 0.01 ppm or more, yet still more preferably 0.1 ppm or more, and particularly preferably 1 ppm or more.

In a more preferred mode of the present invention, decalactone and dodecalactone are simultaneously contained.

Further, in a more preferred mode of the present invention, the lactone is δ-decalactone and/or δ-dodecalactone.

In the present invention, when decalactone and dodecalactone are simultaneously contained, an upper limit of the total concentration of lactone is not particularly limited, but is preferably 1000 ppm or less, more preferably 500 ppm or less, and still more preferably 400 ppm or less relative to the entire food or beverage product.

The lactone in the present invention may be artificially synthesized by a chemical method or derived from a natural product. Preferably, lactone derived from a natural product is used. Further, commercially available lactone may be purchased and used.

In the present invention, the addition of lactone makes it possible to reduce an off-flavor derived from collagen in a food or beverage product containing a specific amount or more of collagen.

Particularly, in a mode in which decalactone is added, it is possible to mask the middle and last notes of off-flavor in the food or beverage product containing a specific amount or more of collagen.

Further, in a mode in which dodecalactone is added, it is possible to mask the top to last notes of off-flavor in the food or beverage product containing a specific amount or more of collagen.

With regard to the content mass ratio of collagen to each of the components in the present invention, more preferred modes will be described hereinbelow.

In a preferred mode of the present invention, collagen and ethyl butyrate are contained.

In the present invention, the content mass ratio of ethyl butyrate to collagen is preferably in a range of 1:100 to 1:10,000, more preferably in a range of 1:100 to 1:5000, still more preferably in a range of 1:100 to 1:1000, and particularly preferably in a range of 1:400 to 1:800.

In addition, the ratio of collagen/ethyl butyrate is preferably 250 or more, more preferably 300 or more, and still more preferably 400 or more.

An upper limit of the ratio of collagen/ethyl butyrate is not particularly limited, but is preferably 100000 or less, more preferably 1000 or less, still more preferably 5000 or less, yet still more preferably 1000 or less, and particularly preferably 800 or less.

The mode described above makes it possible to reduce an off-flavor derived from collagen in a food or beverage product containing a specific amount or more of collagen.

Particularly, according to the present invention, it is possible to reduce an off-flavor characteristic to collagen in a food or beverage product containing a specific amount or more of collagen only by using a catalytic amount of a component relative to a large amount of collagen.

Here, the content mass ratio of collagen to ethyl butyrate can be calculated by dividing the measured mass of collagen contained in the food or beverage product by the mass of ethyl butyrate contained therein.

The masses of collagen and ethyl butyrate contained in the food or beverage product can be measured by a known method for analyzing components.

In a preferred mode of the present invention, one kind or two or more kinds selected from linalool, limonene, and lactones are further contained.

In the present invention, the content mass ratio of linalool to collagen is preferably in a range of 1:100 to 1:5000000, more preferably in a range of 1:100 to 1:50000, still more preferably in a range of 1:100 to 1:5000, yet still more preferably in a range of 1:100 to 1:5000, and particularly preferably in a range of 1:400 to 1:500.

In the present invention, the content mass ratio of limonene to collagen is preferably in a range of 1:100 to 1:5000000, more preferably in a range of 1:100 to 1:50000, still more preferably in a range of 1:100 to 1:5000, yet still more preferably in a range of 1:100 to 1:5000, and particularly preferably in a range of 1:400 to 1:500.

In the present invention, the content mass ratio of lactones to collagen is preferably in a range of 1:100 to 1:5000000, more preferably in a range of 1:100 to 1:50000, still more preferably in a range of 1:100 to 1:5000, yet still more preferably in a range of 1:100 to 1:5000, and particularly preferably in a range of 1:400 to 1:500.

In the present invention, the content mass ratio of one or more substances selected from the group consisting of linalool, limonene, and lactones to collagen is preferably in a range of 1:100 to 1:5000000, more preferably in a range of 1:100 to 1:50000, still more preferably in a range of 1:100 to 1:5000, yet still more preferably in a range of 1:100 to 1:5000, and particularly preferably in a range of 1:400 to 1:500.

When a plurality of substances selected from the group consisting of linalool, limonene, and lactones is contained, preferably, the content mass ratio of each of the components is defined as 1, and the substances are contained such that the content mass ratio of collagen is within the above range.

In addition, the ratio of collagen to linalool is preferably 400 or more, more preferably 600 or more, and still more preferably 800 or more.

An upper limit of the ratio of collagen to linalool is not particularly limited, but is preferably 5000000 or less, more preferably 50000 or less, still more preferably 5000 or less, yet still more preferably 3000 or less, and particularly preferably 1500 or less.

In addition, the ratio of collagen to limonene is preferably 400 or more, more preferably 600 or more, and still more preferably 800 or more.

An upper limit of the ratio of collagen to limonene is not particularly limited, but is preferably 5000000 or less, more preferably 50000 or less, still more preferably 5000 or less, yet still more preferably 3000 or less, and particularly preferably 1500 or less.

In addition, the ratio of collagen to lactones is preferably 400 or more, more preferably 600 or more, and still more preferably 800 or more.

An upper limit of the ratio of collagen to lactones is not particularly limited, but is preferably 5000000 or less, more preferably 50000 or less, still more preferably 5000 or less, yet still more preferably 3000 or less, and particularly preferably 1500 or less.

The mode described above makes it possible to reduce an off-flavor derived from collagen in a food or beverage product containing a specific amount or more of collagen.

Particularly, according to the present invention, it is possible to reduce an off-flavor characteristic to collagen in a food or beverage product containing a specific amount or more of collagen only by using a catalytic amount of a component relative to a large amount of collagen.

Here, the content mass ratio of collagen/linalool, limonene or lactones can be calculated by dividing the measured mass of collagen contained in the food or beverage product by the mass of ethyl butyrate contained therein.

Similarly to that described above, the content mass of linalool, limonene, or lactones in the food or beverage product can be measured by a known method for analyzing components.

In a preferred mode of the present invention, collagen, ethyl butyrate, and one, more preferably two, still more preferably all, of substances selected from linalool, limonene, and lactones are contained.

As described above, the timing of masking the flavor varies depending on the components. Accordingly, in a mode containing all the substances, it is possible to mask the entire off-flavor characteristic to collagen, which is evoked during eating.

Hereinafter, preferred contents according to a combination of components exhibiting a masking effect will be described in detail.

In a preferred mode of the present invention, the content mass ratio of ethyl butyrate to linalool and/or limonene is preferably in a range of 1:0.1 to 1:10, more preferably in a range of 1:0.5 to 1:5, and still more preferably in a range of 1:1 to 3.3.

When linalool and limonene are simultaneously contained, preferably, the content mass ratio of ethyl butyrate is defined as 1, and the substances are contained such that the content mass ratio of each of linalool and limonene is within the above range.

In addition, the ratio of ethyl butyrate to linalool is preferably 0.0001 or more, more preferably 0.001 or more, and still more preferably 0.1 or more.

An upper limit of the ratio of ethyl butyrate to linalool is not particularly limited, but is preferably 10 or less, more preferably 5 or less, and particularly preferably 1 or less.

In addition, the ratio of ethyl butyrate to limonene is preferably 0.0001 or more, more preferably 0.001 or more, and still more preferably 0.1 or more.

An upper limit of the ratio of ethyl butyrate to limonene is not particularly limited, but is preferably 0.1 or less, more preferably 0.005 or less, and still more preferably 0.0005 or less.

The mode described above makes it possible to reduce an off-flavor derived from collagen in a food or beverage product containing a specific amount or more of collagen.

Here, the ratio of ethyl butyrate to linalool or limonene can be calculated by dividing the measured mass of ethyl butyrate contained in the food or beverage product by the mass of linalool or limonene contained therein.

In a preferred mode of the present invention, the content mass ratio of ethyl butyrate to the lactones is preferably in a range of 1:0.1 to 1:10, more preferably in a range of 1:0.5 to 1:5, and still more preferably in a range of 1:0.8 to 1:2.

When a plurality of lactones is contained, preferably, the lactones are contained such that the content mass ratio of the lactones is within the above range relative to 1 part by mass of ethyl butyrate.

The ratio of ethyl butyrate to decalactone or dodecalactone is preferably 0.0001 or more, more preferably 0.001 or more, and still more preferably 0.01 or more.

An upper limit of the ratio of ethyl butyrate to decalactone or dodecalactone is not particularly limited, but is preferably 1 or less, more preferably 0.1 or less, still more preferably 0.01 or less, and particularly preferably 0.001 or less.

The mode described above makes it possible to reduce an off-flavor derived from collagen in a food or beverage product containing a specific amount or more of collagen.

Here, the ratio of ethyl butyrate to lactones can be calculated by dividing the measured mass of ethyl butyrate contained in the food or beverage product by the mass of lactones contained therein.

In the present invention, containing the components within the above range makes it possible to more reliably mask the entire off-flavor characteristic to collagen, which is evoked during eating.

Further, in the mode described above, it is possible to reduce an off-flavor characteristic to collagen in a food or beverage product containing a specific amount or more of collagen only by using a catalytic amount of a component relative to a large amount of collagen.

### [Fruit Juice]

In the present invention, the food or beverage product may contain fruit juice.

Fruit as a raw material of fruit juice is not limited regardless of concentrated fruit juice and straight juice as long as the fruit is used as an ingredient in vegetable juice, a food or beverage product containing fruit juice, fruit juice, or the like.

The content mass of fruit juice in the food or beverage product of the present invention is preferably 1 mass % or more, and more preferably 5 mass % or more in terms of straight juice.

Further, the content mass of fruit juice in the food or beverage product of the present invention is preferably 50 mass % or less, and more preferably 40 mass % or less in terms of straight juice.

In the food or beverage product of the present invention, other components usually used in food or beverage products can be optionally blended as long as the effect of the present invention is not impaired.

Examples of the optional component include sweeteners, acidulants, flavorings, colorings, pH adjusters, edible metal salts, excipients, amino acids, vitamins, minerals, antioxidants, preservatives, antibacterial agents, and bacteriostatic agents.

Preferred modes of the present invention include natural sweeteners.

In the present invention, the content of a natural sweetener is preferably 0.001 mass % or more, more preferably 0.005 mass % or more, and still more preferably 0.01 mass % or more relative to the entire food or beverage product.

An upper limit of the content of the natural sweetener is not particularly limited, but is preferably 10 mass& or less, more preferably 1 mass % or less, still more preferably 0.1 mass % or less, and particularly preferably 0.05 mass % or less relative to the entire food or beverage product.

In the present invention, the sweetener preferably includes stevia and/or Rakanka (Siraitia grosvenorii).

When stevia and Rakanka are contained simultaneously, the content mass ratio of stevia to Rakanka is preferably in a range of 1:1 to 30:1, more preferably in a range of 1:1 to 20:1, and particularly preferably in a range of 1:1 to 19:1.

Further, the content mass ratio of stevia to Rakanka is preferably 1 or more, more preferably 5 or more, and particularly preferably 10 or more.

An upper limit of the content mass ratio of stevia to Rakanka is not particularly limited, but is preferably 30 or less, more preferably 25 or less, and particularly preferably 20 or less.

Here, the content mass ratio of stevia to Rakanka can be calculated by dividing the measured mass of stevia contained in the food or beverage product by the mass of Rakanka contained therein.

Further, the content mass of stevia and Rakanka in the food or beverage product can be measured by a known method for analyzing components.

A food or beverage product containing a natural sweetener of stevia and/or Rakanka has tended to have an off-flavor characteristic to collagen as compared with the case of using an artificial sweetener. According to the present invention, when a natural sweetener is contained, it is possible to more reliably mask the off-flavor characteristic to collagen in the food or beverage product.

The mode of the present invention is not particularly limited as long as it is a food or beverage product, but is preferably a beverage.

The Brix value of the food or beverage product of the present invention is preferably 10 or more, and more preferably 15 or more.

Further, the Brix value of the food or beverage product is preferably 60 or less, more preferably 45 or less, and still more preferably 35 or less.

As a method for calculating the Brix value of the food or beverage product, for example, a method for measuring the Brix value using a saccharimeter can be used. Examples of the method can include a method for calculating the Brix value using a refractometer, and a method for determining the Brix value by comparing the concentration of sugar in the food or beverage product with a calibration curve of Brix values.

Here, the Brix value of the food or beverage product can be adjusted by adjusting the content mass of the soluble solid contents in the food or beverage product.

The pH of the food or beverage product is preferably 2 or more, and more preferably 3 or more.

Further, the pH of the food or beverage product is preferably 6 or less, more preferably 5 or less, and still more preferably 4.5 or less.

The kind of the pH adjuster is not particularly limited as long as the effect of the present invention is achieved, but for example, it can be appropriately adjusted by using one or more known pH adjusters.

The viscosity of the food or beverage product at 20° C. is preferably 2 cP or more, more preferably 3 cP or more, and more preferably 5 cP or more.

The viscosity of the food or beverage product at 20° C. is preferably 50 cP or less, and more preferably 30 cP or less.

The viscosity of the food or beverage product at 20° C. may be a value measured using a B-type viscometer (manufactured by TOKYO KEIKI INC., 20° C., measurement time 60 seconds, rotor and number of rotations adjusted as appropriate according to the viscosity of the sample).

The container used for the food or beverage product of the present invention is not particularly limited, and may be a paper container, a PET bottle, a glass bottle, or a can.

The capacity of the container is also not particularly limited.

The capacity of the container is preferably 30 mL or more, and more preferably 100 mL or more.

The capacity of the container is preferably 2000 mL or less, more preferably 1600 mL or less, and still more preferably 600 mL or less.

### <Method for Producing Food or Beverage Product>

Hereinafter, a method for producing a food or beverage product of the present invention will be described.

The method for producing a food or beverage product of the present invention is a method for producing a collagen-rich food or beverage product in which an off-flavor characteristic to collagen is masked, the method including mixing 5 mass % or more of collagen with ethyl butyrate.

According to the production method of the present invention, it is possible to efficiently produce a collagen-rich food or beverage product in which an off-flavor characteristic to collagen is masked.

In addition, the description of the food or beverage product of the present invention can be incorporated as a preferred mode (the components and physical properties) in the method for producing a food or beverage product of the present invention.

### <Method for Reducing Odor of Collagen>

Hereinafter, a method for reducing an odor of collagen of the present invention will be described.

The method for reducing an odor of collagen according to the present invention is a method for reducing an odor of collagen in a food or beverage product containing 5 mass % or more of collagen, the method including mixing 5 mass % or more of collagen with ethyl butyrate.

In addition, the description of the food or beverage product of the present invention can be incorporated as a preferred mode (the components and physical properties) in the method for reducing an odor of collagen of the present invention.

### EXAMPLES

Hereinafter, the present invention will be described in more detail by way of examples. However, the present invention is not limited to the following examples unless the gist of the present invention is exceeded. Unless otherwise stated, pig-derived collagen having an average molecular weight of 2,000 was used in the examples.

A test was conducted to confirm the effect of masking the off-flavor characteristic to collagen in each of the components contained in the present invention. Unless otherwise stated, each numerical value in each table means mass percent relative to the entire beverage.

### 1. Production of Beverage

The components of the formulations shown in Table 1 were mixed with water to form a base solution. Samples of examples and comparative examples were prepared from the base solution.

TABLE 1

| Raw material name | Additive amount |
|---|---|
| Collagen peptide | 5 to 40% |
| Sweetener (stevia, Rakanka) | 0.015% |
| Acidulant | 1.00% |

### 2. Evaluation Method

Sensory evaluation was conducted by three evaluators: experts in production of beverages.

The evaluators tasted 20 mL of respective test food or beverage products, and then they conducted sensory evaluation for the following items (1) and (2), in light of the definition described below.

### (1) Degree of Reduction of Off-Flavor (Masking)

The degree of masking of the off-flavor characteristic to collagen was evaluated based on the score criteria described below.

Here, the minimum unit for evaluation was 1.

Note that an average value of the results of sensory evaluation by the three evaluators: experts in production of beverages was used as a value of the degree of masking. Here, a mode containing no ethyl butyrate in each of the examples was used as a control.
Evaluation score 1: The characteristic flavor derived from the collagen raw material was hardly reduced, and the flavor deteriorated.
Evaluation score 2: The characteristic flavor derived from the collagen raw material was not reduced, and the flavor was slightly deteriorated.
Evaluation score 3: There was no change in flavor as compared with the control.
Evaluation score 4: The characteristic flavor derived from the collagen raw material was reduced, and the flavor masking effect was slightly observed.
Evaluation score 5: The characteristic flavor derived from the collagen raw material was greatly reduced, and the flavor masking effect was observed.

### (2) Part of Reduced (Masked) Off-Flavor

It was evaluated which part of the top, middle, and last notes of each test food or beverage product particularly had a masking effect.

In addition, T, M, or L in each table below represents which part of the off-flavor of collagen is masked (T: top, M: middle, L: last).

### 3. Test

### Test Example 1

As described in Table 1, a base solution containing a high concentration of collagen was mixed with water, and samples were prepared to have collagen concentrations of 5, 8, 10, and 40 mass %.

Thereafter, ethyl butyrate was added to each of the samples, and the masking effect of the off-flavor of collagen was evaluated by the method 2 as described above. The results are shown in Table 2.

TABLE 2

| | Com- | | | | | |
|---|---|---|---|---|---|---|
| | parative | Ex- | Ex- | Ex- | Ex- | Ex- |
| Raw | Example | ample | ample | ample | ample | ample |
| material | 1-1 | 1-1 | 1-2 | 1-3 | 1-4 | 1-5 |
| Collagen | 40 | 10 | 10 | 10 | 10 | 10 |
| Ethyl | 0.2 | 0.01 | 0.005 | 0.001 | 0.0001 | 0.00001 |
| butyrate | | | | | | |
| Concen- | 2000 ppm | 100 ppm | 50 ppm | 10 ppm | 1 ppm | 100 ppb |
| tration | | | | | | |
| of ethyl | | | | | | |
| butyrate | | | | | | |
| Masking | 5.0 | 5.0 | 5.0 | 5.0 | 4.3 | 4.0 |
| of | | | | | | |
| collagen | | | | | | |
| (reduced | | | | | | |
| off-flavor) | | | | | | |
| *average | | | | | | |
| score | | | | | | |
| Part of | T, M, L | T | T | T | T | T |
| masked | | | | | | |
| off-flavor | | | | | | |
| Col- | 2000 | 1000 | 2000 | 10000 | 100000 | 1000000 |
| lagen/ | | | | | | |
| ethyl | | | | | | |
| butyrate | | | | | | |
| | Ex- | Ex- | Ex- | Ex- | Ex- | Ex- |
| Raw | ample | ample | ample | ample | ample | ample |
| material | 1-6 | 1-7 | 1-8 | 1-9 | 1-10 | 1-11 |
| Collagen | 10 | 10 | 10 | 10 | 8 | 8 |
| Ethyl | 0.000001 | 0.0000001 | 0.0000005 | 0.00000025 | 0.001 | 0.000001 |
| butyrate | | | | | | |
| Concen- | 10 ppb | 1 ppb | 5 ppb | 2.5 ppb | 10 ppm | 10 ppb |
| tration | | | | | | |
| of ethyl | | | | | | |
| butyrate | | | | | | |
| Masking | 4.0 | 3.0 | 4.0 | 3.0 | 4.7 | 4 |
| of | | | | | | |
| collagen | | | | | | |
| (reduced | | | | | | |
| off-flavor) | | | | | | |
| *average | | | | | | |
| score | | | | | | |
| Part of | T | T | T | T | T, M | T. M |
| masked | | | | | | |
| off-flavor | | | | | | |
| Col- | 10000000 | 100000000 | 20000000 | 40000000 | 8000 | 8000000 |
| lagen/ | | | | | | |
| ethyl | | | | | | |
| butyrate | | | | | | |

### (Results and Discussion)

As shown in Table 2, beverages containing 5 mass % or more of collagen and 10 ppm or more of ethyl butyrate (a content mass ratio of ethyl butyrate to collagen being in a range of 1:200 to 1:10000) were found to more reliably mask the characteristic off-flavor of collagen when the content mass of collagen was large.

Further, the addition of ethyl butyrate was found to enable the top note of off-flavor of collagen to be masked.

### Test Example 2

Hereinafter, ethyl butyrate and other components (linalool, limonene, and lactones) were each added to a sample containing 10 mass % of collagen described in Table 1. Each of the evaluators confirmed and evaluated the effect of masking off-flavor of collagen in each of the components, in a similar manner to Test Example 1. The results are shown in Tables 3 and 4.

### Test Example 2-1

The evaluation was conducted by changing the concentration range of linalool or limonene based on the composition of Test Example 2.

TABLE 3

| | Ex- | Ex- | Ex- | Ex- | Ex- | Ex- | Ex- | Ex- |
|---|---|---|---|---|---|---|---|---|
| Raw | ample | ample | ample | ample | ample | ample | ample | ample |
| material | 2-1 | 2-2 | 2-3 | 2-4 | 3-1 | 3-2 | 3-3 | 3-4 |
| Collagen | 10 | 10 | 10 | 10 | 10 | 10 | 10 | 10 |
| Ethyl | 0.000001 | 0.000001 | 0.000001 | 0.000001 | 0.000001 | 0.000001 | 0.000001 | 0.000001 |
| butyrate | | | | | | | | |
| Linalool | 0.01 | 0.005 | 0.0005 | 0.000005 | | | | |
| Limonene | | | | | 0.01 | 0.005 | 0.0005 | 0.000005 |
| Concen- | 100 ppm | 50 ppm | 5 ppm | 5 ppb | 100 ppm | 50 ppm | 5 ppm | 5 ppb |
| tration of | | | | | | | | |
| linalool or | | | | | | | | |
| limonene | | | | | | | | |
| Masking of | 5.0 | 5.0 | 5.0 | 4.7 | 5.0 | 5.0 | 4.0 | 3.7 |
| collagen | | | | | | | | |
| (reduced | | | | | | | | |
| off-flavor) | | | | | | | | |
| *average | | | | | | | | |
| score | | | | | | | | |
| Part of | T, M, L | T, M, L | T, M, L | T, M, L | T, M | T, M | T, M | T, M |
| masked | | | | | | | | |
| off-flavor | | | | | | | | |
| Collagen/ | 1000 | 2000 | 20000 | 2000000 | 1000 | 2000 | 20000 | 2000000 |
| other | | | | | | | | |
| components | | | | | | | | |
| (linalool or | | | | | | | | |
| limonene) | | | | | | | | |
| Ethyl | 0.0001 | 0.0002 | 0.002 | 0.2 | 0.0001 | 0.0002 | 0.002 | 0.2 |
| butyrate/ | | | | | | | | |
| other | | | | | | | | |
| components | | | | | | | | |
| (linalool or | | | | | | | | |
| limonene) | | | | | | | | |

### (Results and Discussion)

As shown in Table 3, beverages containing 5 mass % or more of collagen and 5 ppm or more of linalool (a content mass ratio of linalool to collagen being in a range of 1:100 to 1:2000000) were found to more reliably mask the characteristic off-flavor of collagen when the content mass of collagen was large.

Further, the addition of linalool was found to enable the top to last notes of off-flavor of collagen to be masked.

Furthermore, beverages containing 5 mass % or more of collagen and 50 ppm or more of limonene (a content mass ratio of limonene to collagen being in a range of 1:100 to 1:2000) were found to more reliably mask the characteristic off-flavor of collagen when the content mass of collagen was large.

Moreover, the addition of limonene was found to enable the top and middle notes of off-flavor of collagen to be masked.

### Test Example 2-2

The evaluation was conducted by changing the concentration range of lactones based on the composition of Test Example 2.

TABLE 4

| | Ex- | Ex- | Ex- | Ex- | Ex- | Ex- | Ex- | Ex- |
|---|---|---|---|---|---|---|---|---|
| Raw | ample | ample | ample | ample | ample | ample | ample | ample |
| material | 4-1 | 4-2 | 4-3 | 4-4 | 5-1 | 5-2 | 5-3 | 5-4 |
| Collagen | 10 | 10 | 10 | 10 | 10 | 10 | 10 | 10 |
| Ethyl | 0.000001 | 0.000001 | 0.000001 | 0.000001 | 0.000001 | 0.000001 | 0.000001 | 0.000001 |
| butyrate | | | | | | | | |
| δ-deca- | 0.005 | 0.0001 | 0.000001 | 0.00000001 | | | | |
| lactone | | | | | | | | |
| δ- | | | | | 0.005 | 0.0001 | 0.000001 | 0.00000001 |
| dodeca- | | | | | | | | |
| lactone | | | | | | | | |
| Concen- | 50 ppm | 1 ppm | 10 ppb | 0.1 ppb | 50 ppm | 1 ppm | 10 ppb | 0.1 ppb |
| tration | | | | | | | | |
| of lactone | | | | | | | | |
| Masking | 5.0 | 4.3 | 4.3 | 3.7 | 5.0 | 4.7 | 4.3 | 3.7 |
| of collagen | | | | | | | | |
| (reduced | | | | | | | | |
| off-flavor) | | | | | | | | |
| *average | | | | | | | | |
| score | | | | | | | | |
| Part of | M, L | M, L | M, L | M, L | T, M. L | T, M. L | T, M. L | T, M. L |
| masked | | | | | | | | |
| off-flavor | | | | | | | | |
| Collagen | 2000 | 100000 | 10000000 | 1000000000 | 2000 | 100000 | 10000000 | 1000000000 |
| other | | | | | | | | |
| components | | | | | | | | |
| (deca- | | | | | | | | |
| lactone or | | | | | | | | |
| dodeca- | | | | | | | | |
| lactone) | | | | | | | | |
| Ethyl | 0.0002 | 0.01 | 1 | 100 | 0.0002 | 0.01 | 1 | 100 |
| butyrate/ | | | | | | | | |
| other | | | | | | | | |
| components | | | | | | | | |
| (deca- | | | | | | | | |
| lactone or | | | | | | | | |
| dodeca- | | | | | | | | |
| lactone) | | | | | | | | |

### (Results and Discussion)

As shown in Table 4, beverages containing 5 mass % or more of collagen and 50 ppm or more of δ-decalactone (a content mass ratio being in a range of 1:100 to 1:2000) were found to more reliably mask the characteristic off-flavor of collagen when the content mass of collagen was large.

Further, it was found that, in food or beverage products containing 5 mass % or more of collagen, the addition of δ-decalactone enabled the middle and last notes of off-flavor of collagen to be masked.

Furthermore, beverages containing 5 mass % or more of collagen and 50 ppm or more of δ-dodecalactone (a content mass ratio being in a range of 1:100 to 1:100000) were found to more reliably mask the characteristic off-flavor of collagen when the content mass of collagen was large.

Moreover, it was found that, in food or beverage products containing 5 mass % or more of collagen, the addition of δ-dodecalactone enabled the top to last notes of off-flavor of collagen to be masked.

### Test Example 3

A combination of an aroma component and a sweetener: substances for efficiently masking the off-flavor of collagen were examined.

In Test Example 3, solutions of each of the examples were prepared according to the formulations described in Table 5.

Water was used to dilute the solutions.

In Test Example 3, a preparation containing 95 mass % of a stevia extract and 5 mass % of a Rakanka extract was used as a sweetener.

In the formulation containing stevia alone, a preparation of stevia extract (main component: RebA) was used.

Further, in the formulation containing Rakanka alone, a preparation containing 50% of mogroside V was used.

In this test example, the degrees of sweetness of the formulations were equalized. The degrees of sweetness of sweetener raw materials were determined in accordance with the standard of each of the sweetener raw materials, and the additive amounts of these raw materials were determined.

With regard to the formulations, the evaluators confirmed and evaluated the effect of masking off-flavor of collagen in each of the components, in a similar manner to Test Example 1. The results are shown in Table 5.

### [Table 5]

TABLE 5

| Raw material | Example 6-1 | Example 6-2 | Example 6-3 |
|---|---|---|---|
| Collagen | 8 | 8 | 8 |
| Ethyl butyrate | 0.002 | 0.002 | 0.002 |
| δ-dodecalactone | 0.00001 | 0.00001 | 0.00001 |
| Concentration of ethyl | 20 ppm | 20 ppm | 20 ppm |
| butyrate | | | |
| Concentration of δ- | 0.1 ppm | 0.1 ppm | 0.1 ppm |
| dodecalactone | | | |
| Sweetener (stevia and | 0.015 | | |
| Rakanka) | | | |
| Sweetener (stevia alone) | | 0.015 | |
| Sweetener (Rakanka alone) | | | 0.02 |
| Masking of collagen (reduced | 5 | 4 | 4.3 |
| off-flavor) *average score | | | |
| Part of masked off-flavor | T, M, L | M | T, M |

### (Results and Discussion)

As shown in Table 5, beverages containing ethyl butyrate and dodecalactone were found to mask the off-flavor characteristic to collagen when the content mass of collagen was large.

Further, the beverages containing a high concentration of collagen, ethyl butyrate, dodecalactone, and a sweetener (stevia and/or Rakanka) were found to mask the off-flavor of collagen.

Particularly, the beverage containing ethyl butyrate, dodecalactone, stevia, and Rakanka was found to mask the top to last notes of off-flavor of collagen.

### Production Example 1

A collagen-rich beverage was produced according to the formulation shown in Table 6 below.

The collagen-rich beverage prepared in Production Example 1 had a good flavor with the top to last notes of off-flavor of collagen masked.

TABLE 6

| Production Example 1 | | |
|---|---|---|
| Collagen | 8 | |
| Ethyl butyrate | 0.0005 | |
| Linalool | 0.00005 | |
| Limonene | 0.001 | |
| Concentration of ethyl butyrate | 5 | ppm |
| Concentration of linalool | 0.5 | ppm |
| Concentration of limonene | 10 | ppm |

| | |
|---|---|
| Masking of collagen (reduced off- | 5.0 |
| flavor) *average score | |
| Part of masked off-flavor | T, M, L |
| Ethyl butyrate/other components | 0.48 |
| (total of linalool and limonene) | |

### Production Example 2

A collagen-rich beverage was produced according to the formulation shown in Table 7 below.

The collagen-rich beverage prepared in Production Example 2 had a good flavor with the top to last notes of off-flavor of collagen masked.

TABLE 7

| Production Example 2 | |
|---|---|
| Collagen | 8 |
| Ethyl butyrate | 0.002 |
| δ-decalactone | 0.00005 |
| δ-dodecalactone | 0.00001 |
| Concentration of ethyl butyrate | 20 ppm |
| Concentration of δ-decalactone | 0.5 ppm |
| Concentration of δ-dodecalactone | 0.1 ppm |
| Masking of collagen (reduced off- | 5.0 |
| flavor) *average score | |
| Part of masked off-flavor | T, M, L |
| Ethyl butyrate/lactones (total | 33 |
| of decalactone and dodecalactone) | |

### (Conclusion)

Production Examples 1 and 2 revealed that the collagen-rich beverage containing an aroma component of the present invention had a good flavor with the top to last notes of off-flavor of collagen masked.

The present invention can be used for the production of food or beverage products.

What is claimed is:

1. A food or beverage product comprising:
ethyl butyrate; and
5 mass % or more of collagen.

2. The food or beverage product according to claim 1, wherein
a content mass ratio of ethyl butyrate to collagen is in a range of 1:100 to 1:10,000.

3. The food or beverage product according to claim 1, wherein
the food or beverage product contains one kind or two or more kinds selected from linalool, limonene, and lactones.

4. The food or beverage product according to claim 3, wherein
a content mass ratio of one or more substances selected from the group consisting of linalool, limonene, and lactones to collagen is in a range of 1:100 to 1:5000000.

5. The food or beverage product according to claim 3, wherein
a content mass ratio of ethyl butyrate to linalool and/or limonene is in a range of 1:0.1 to 1:10.

6. The food or beverage product according to claim 3, wherein
a content mass ratio of ethyl butyrate to lactones is in a range of 1:0.1 to 1:10.

7. The food or beverage product according to claim 3, wherein
the lactones include δ-decalactone and/or δ-dodecalactone.

8. The food or beverage product according to claim 2, wherein
the food or beverage product contains one kind or two or more kinds selected from linalool, limonene, and lactones.

9. The food or beverage product according to claim 8, wherein
a content mass ratio of one or more substances selected from the group consisting of linalool, limonene, and lactones to collagen is in a range of 1:100 to 1:5000000.

10. The food or beverage product according to claim 8, wherein
a content mass ratio of ethyl butyrate to linalool and/or limonene is in a range of 1:0.1 to 1:10.

11. The food or beverage product according to claim 8, wherein
a content mass ratio of ethyl butyrate to lactones is in a range of 1:0.1 to 1:10.

12. The food or beverage product according to claim 8, wherein
the lactones include δ-decalactone and/or δ-dodecalactone.

13. A method for producing a food or beverage product containing collagen, the method comprising
mixing 5 mass % or more of collagen with ethyl butyrate.

14. A method for producing a food or beverage product containing collagen according to claim 13, wherein
a content mass ratio of ethyl butyrate to collagen is in a range of 1:100 to 1:10,000.

15. A method for reducing an odor of collagen in a food or beverage product, wherein
the food or beverage product contains ethyl butyrate as an active substance and 5 mass % or more of collagen.

16. A method for reducing an odor of collagen in a food or beverage product according to claim 15, wherein
a content mass ratio of ethyl butyrate to collagen is in a range of 1:100 to 1:10,000.
